(19) United States
(12) Patent Application Publication
(10) Pub. No.: US 2026/0178074 A1
(43) Pub. Date: Jun. 25, 2026

(54) DATA CLOCK RECOVERY CIRCUIT

(71) Applicant: Montage Electronics (Shanghai) Co., Ltd., Shanghai (CN)

(72) Inventors: GuoKai Yi, Shanghai (CN); YuanFei Nie, Shanghai (CN)

(73) Assignee: Montage Electronics (Shanghai) Co., Ltd., Shanghai (CN)

(21) Appl. No.: 19/387,627

(22) Filed: Nov. 13, 2025

(30) Foreign Application Priority Data
Dec. 23, 2024 (CN) 202411907251.8

(51) Int. Cl. G06F 1/08; G06F 1/14

(52) U.S. Cl. CPC G06F 1/08; G06F 1/14

(57) ABSTRACT

A data clock recovery circuit includes a multi-task integrator, a controller, and an analog-to-digital converter, an equalizer, a decider, an error calculator, a phase detection estimator, a loop filter, and a phase interpolator sequentially coupled in series. The multi-task integrator is coupled between a coupling path of the phase interpolator and the loop filter, and selects one of a phase adjustment signal and a bias signal according to the mode selection signal to output to the phase interpolator. The controller is coupled to the multi-task integrator and is configured to generate a mode selection signal.

### CROSS-REFERENCE TO RELATED APPLICATION

This application claims the priority benefit of China application serial no. 202411907251.8, filed on Dec. 23, 2024. The entirety of the above-mentioned patent application is hereby incorporated by reference herein and made a part of this specification.

### BACKGROUND

### Technical Field

The disclosure relates to a data clock recovery circuit, and in particular to a data clock recovery circuit configured to optimize clock jitter tolerance.

### Description of Related Art

In a baseband communication system, as data transmission rates increase and channel losses maximizes, inter-symbol interference (ISI) also becomes serious. Since extracting a clock from data requires a highly reliable data decision, the problem of ISI becomes more serious for a transmission system using high-order pulse amplitude modulation signals. To deal with this situation, a data clock recovery circuit usually introduces equalization technology, such as adding an equalizer to the circuit, to reduce ISI and improve data decision reliability.

In a transmission system without a training sequence, the adaptive update of the equalizer coefficient adopts a non-data-aided (NDA) manner, and a convergence point and convergence process are closely related to a sampling phase. Phase convergence and post-convergence jitter of the data clock recovery circuit depend not only on the transfer function of a phase interpolator and a loop filter, but also on output of phase detection. When an equalizer loop and a phase detection tracking loop are jointly optimized, both equalizer coefficient and sampling phase converge to a minimum decision error. When faced with channels with large attenuation and high-order pulse amplitude modulation signals, two problems often occur as follows.
(1) During an initialization process, the equalizer coefficient has not yet converged, but performance of the phase detection is heavily dependent on the decision accuracy. If a symbol error rate (SER) is very high, phase decision errors are frequent, reliability of phase detection information may be poor, and a clock loop may be difficult to establish on a stable sampling spot, which in turn affects the convergence of the equalizer coefficient. For a long channel with large attenuation, this problem is more serious and may even affect the locking of the sampling clock and phase.
(2) When the sampling phase jitters left and right at a position where an eye is most open in an equalized eye diagram, the equalizer coefficient may be driven to change adaptively. However, due to different error gradients on the left and right sides of the eye diagram, the equalizer coefficient may change to one side and generate a new equalized eye diagram, driving the sampling phase offset. In most cases, the sampling phase eventually converges to a position biased to one side, which greatly reduces the jitter tolerance that the data clock recovery circuit may withstand.

### SUMMARY

The disclosure aims to provide a data clock recovery circuit capable of optimizing clock jitter tolerance.

According to an embodiment of the disclosure, a data clock recovery circuit includes a multi-task integrator, a controller, and an analog-to-digital converter, an equalizer, a decider, an error calculator, a phase detection estimator, a loop filter, and a phase interpolator sequentially coupled in series. The multi-task integrator is coupled between a coupling path of the phase interpolator and the loop filter, and selects one of the phase adjustment signal and the bias signal according to the mode selection signal to output to the phase interpolator. The controller is coupled to the multi-task integrator and generates a mode selection signal by monitoring convergence of an equalizer coefficient.

### BRIEF DESCRIPTION OF THE DRAWINGS

FIG. 1 is a schematic diagram of a data clock recovery circuit according to an embodiment of the disclosure.

FIG. 2 is a control flow chart of the data clock recovery circuit in FIG. 1 according to an embodiment of the disclosure.

FIG. 3A is a diagram of a relationship between an eye width and a magnitude of residual ISI after equalization when a sampling clock is locked at different phases according to an embodiment of the disclosure.

FIG. 3B is a schematic diagram of sampling in a fast phase integration mode and in a normal mode according to an embodiment of the disclosure.

FIG. 3C illustrates convergence targets of equalizer coefficients of an equalizer when a sampling clock is locked to different phases.

### DESCRIPTION OF THE EMBODIMENTS

The following describes the implementation of the present application through specific examples. Those skilled in the art can easily understand other advantages and effects of the present application from the contents disclosed in this specification. The present application may also be implemented or applied through other different specific implementation methods, and the details in this specification may also be modified or changed in various ways based on different viewpoints and applications without departing from the spirit of the present application. It should be noted that the following embodiments and features therein may be combined with each other if there is no conflict.

It should be noted that the illustrations provided in the following embodiments are only used to illustrate the basic concept of the present application in a schematic manner, and therefore the illustrations only show components related to the present application rather than being drawn according to the number, shape and size of components in actual implementation. In actual implementation, the type, quantity and proportion of each component may be changed arbitrarily, and the component layout may also be more complicated.

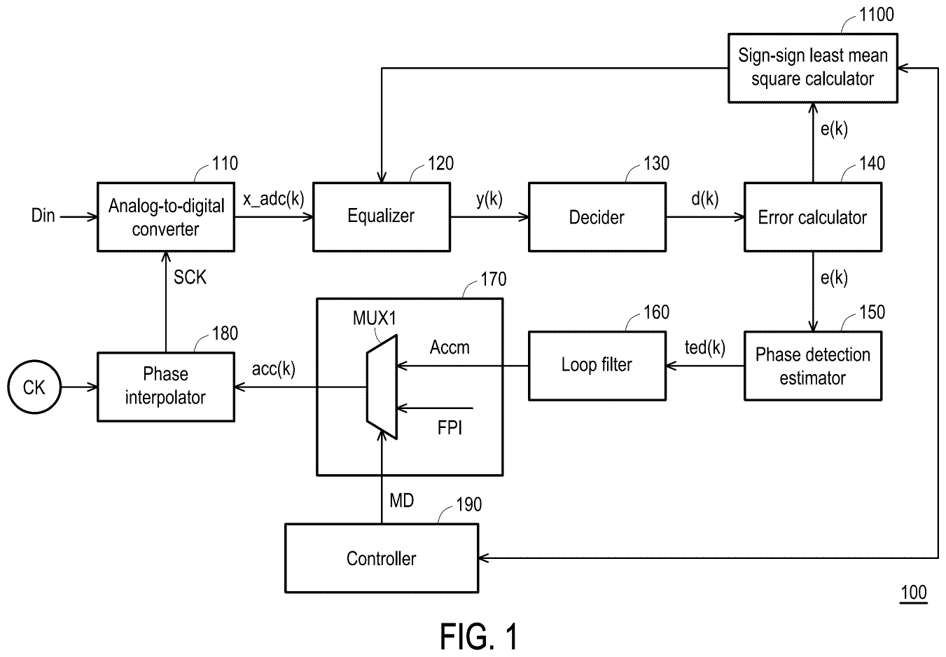

Please refer to FIG. 1. FIG. 1 is a schematic diagram of a data clock recovery circuit according to an embodiment of the disclosure. A data clock recovery circuit 100 includes an analog-to-digital converter 110, an equalizer 120, a decider 130, an error calculator 140, a phase detection estimator 150, a loop filter 160, a phase interpolator 180, a multi-task integrator 170, a controller 190, and a sign-sign least mean square calculator 1100. The analog-to-digital converter 110, the equalizer 120, the decider 130, the error calculator 140, the phase detection estimator 150, the loop filter 160, and the phase interpolator 180 are sequentially coupled to each other in series.

The analog-to-digital converter 110 is configured to sample an analog signal Din under control of a sampling clock signal SCK, and convert the sampled signal into a digital signal for output. An output signal of the analog-to-digital converter 110 is x_adc(k)=x(kT θ), where x(t) represents the analog signal Din, k is an integer, T is a sampling period, and θ is a sampling phase.

The equalizer 120 receives the output signal x_adc(k) of the analog-to-digital converter 110 and performs equalization on the output signal x_adc(k) to output an equalized signal y(k). Specifically, the equalizer 120 may reduce or eliminate ISI (inter-symbol interference) by performing convolution and feedback calculation on the output signal x_adc(k) of the analog-to-digital converter 110, so as to restore an ideal data value of the output signal x_adc(k) without ISI as much as possible. In this embodiment, the equalizer 120 may be a feed-forward equalizer (FFE), a decision feedback equalizer (DFE), or a combination of FFE and DFE. Taking the equalizer 120 as FFE as an example, the output signal y(k) generated by the equalizer 120 is as follows:

$$y ( k ) = {\sum }_{i = - pre\_tap}^{pst\_tap} {w}_{i} \times x\_adc ( k - i )$$

where w is an equalizer coefficient, and pre_tap and pst_tap are numbers of pre-tap and post-tap of the equalizer respectively. In this embodiment, the FFE equalizer has a total of (pre_tap+pst_tap+1) taps.

The decider 130 receives the signal y(k) generated by the equalizer 120, and makes decision on the signal y(k) according to coding and modulation manners of a transmitting end of the analog signal Din to generate a decision result d(k). Specifically, the decider 130 may set a decision threshold according to the coding and modulation manners used by the transmitting end. Different coding and modulation manners correspond to different decision criteria. For example, for a non-return-to-zero line code (NRZ) signal, it is only necessary to determine whether the signal y(k) is high or low, and an output result is −1 (for example, corresponding to a low level) or 1 (for example, corresponding to a high level). A 4-level pulse amplitude modulation (PAM4) signal includes four discrete levels, so there are four kinds of decision results d(k) output after the decision, namely −3 or −1 or 1 or 3, and each represents a different state. In some embodiments, the decider may adopt any suitable decision manner.

In this embodiment, the decision result d(k)=sel_min(setting set, abs(y(k)-setting set)) is outputted by the decider 130, where sel_min( ) is an output function configured to select a corresponding value from a first parameter according to a minimum value of a second parameter. The first parameter is a set, the second parameter is an absolute difference set abs (y(k)-set), and abs( ) is a function configured to calculate an absolute value. For example, for the NRZ signal, a set is {−1, 1}, and for the PAM4 signal, a set is {−3, −1, 1, 3}.

The error calculator 140 is configured to calculate a difference between the output signal y(k) of the equalizer 120 and the decision result d(k) of the decider 130 and generate an error signal e(k), where e(k)=y(k)−d(k).

The sign-sign least mean square calculator 1100 is coupled to the equalizer 120, the error calculator 140, and the controller 190. The sign-sign least mean square calculator 1100 is configured to adaptively adjust the equalizer coefficient w according to the error signal e(k). In this embodiment, the sign-sign least mean square calculator 1100 may adjust the equalizer coefficient by using methods such as sign-sign-least-mean square (SS-LMS) or data-data-least-mean square (DD-LMS) or recursive-least-squares (RLS). The equalizer 120 is taken as FFE as an example, wᵢ(k+1)=wᵢ(k)−μ×sign(x_adc(k−i))×sign (e(k)), where i is an integer, i∈[−pre_tap, pst_tap], u is a step length, and sign( ) is a function returning a sign of an expression.

The phase detection estimator 150 receives the error signal e(k), and performs phase error estimation according to the error signal e(k) to output a phase error estimation signal. The phase detection estimator 150 may perform phase error estimation by using an MM (Mueller-Muller) algorithm or a BB (Bang-Bang) algorithm. A phase error estimation signal ted(k) is configured to characterize an error of the current sampling phase. If the phase error estimation signal ted(k) is negative, it is shown that sampling lags. On the contrary, if the phase error estimation signal ted(k) is positive, it is shown that the sampling is advanced.

The loop filter 160 may be a phase integral loop filter (PI loop filter). The loop filter 160 is configured to receive the phase error estimation signal ted(k) and filter the phase error estimation signal ted(k) to eliminate the excessively fast jump in the phase error estimation signal ted(k) to generate a stable filtered output signal.

The multi-task integrator 170 receives a bias signal FPI and the filtered output signal generated by the loop filter 160, integrates the filtered output signal generated by the loop filter 160 to obtain a phase adjustment signal Accm, and outputs one of the phase adjustment signal Accm or the bias signal FPI under control of the controller 190. In the embodiment of the disclosure, an output of the multi-task integrator 170 may be collectively referred to as a phase integration signal acc(k).

The multiplexer integrator 170 may include a multiplexer MUX1. An input end of the multiplexer MUX1 may receive the phase adjustment signal Accm, the other input end of the multiplexer MUX1 may receive the bias signal FPI, and a control end of the multiplexer MUX1 may receive a mode selection signal MD provided by the controller 190. The controller 190 controls the output of the multi-tasking integrator 170 through the mode selection signal MD. When the multi-task integrator 170 outputs the phase adjustment signal Accm under the control of the controller 190, the data clock recovery circuit 100 is in a normal mode. When the multi-task integrator 170 outputs the bias signal FPI under the control of the controller 190, the data clock recovery circuit 100 is in a fast phase integration mode. In this embodiment, the mode selection signal MD may be a 1-bit digital signal. When the mode selection signal MD is a first logic value, it is shown that the data clock recovery circuit 100 is in the normal mode. In contrast, when the mode selection signal MD is a second logic value, it is shown that the data clock recovery circuit 100 is in the fast phase integration mode. The first logic value is different from the second logic value.

Please note that in this embodiment, the bias signal FPI may be set to a larger value, so that a difference between the bias signal FPI and the phase adjustment signal Accm is larger than a first preset threshold, such as 5000 ppm. In an embodiment, the bias signal FPI may be set to a fixed constant value. When setting the value of the bias signal FPI, a settable range of the actual device must also be considered.

The phase interpolator 180 receives the phase integration signal acc(k), and adjusts a local clock signal CK according to the phase integration signal acc(k) to generate a sampling clock signal SCK. Specifically, the phase interpolator 180 may add a controllable delay to the local clock signal CK to generate the sampling clock signal SCK. The controllable delay PI(k)=ratio*acc(k), where ratio is a constant configured to characterize a fixed proportional relationship between the designed controllable delay PI(k) and the phase integral signal acc(k). When the controllable delay PI(k) is greater than 0, a phase of the sampling clock signal SCK may be faster than a phase of the local clock signal CK. When the controllable delay PI(k) is less than 0, a phase of the sampling clock signal SCK may be slower than a phase of the local clock signal CK. When the controllable delay PI(k) is equal to 0, a phase of the sampling clock signal SCK may be equal to a phase of the local clock signal CK.

When the data clock recovery circuit 100 is initialized, the controller 190 controls the data clock recovery circuit 100 to be in the fast phase integration mode through the mode selection signal MD. The sign-sign least mean square calculator 1100 continuously calculates and updates the equalizer coefficients according to the error signal e(k) output by the error calculator 140, and outputs the updated equalizer coefficients to the equalizer 120 and the controller 190. The controller 190 monitors the convergence of the equalizer coefficients in real time according to the received equalizer coefficients. In an embodiment, the controller 190 records the equalizer coefficients and then compares a difference between the two most recently recorded equalizer coefficients. If the differences of all the equalizer coefficients are within a preset range, such as 0 to 0.05, that is, the differences of all the equalizer coefficients do not exceed 0.05, the controller 190 determines that the equalizer coefficients have converged. At this time, the controller 190 may notify the sign-sign least mean square calculator 1100 to stop calculating the equalizer coefficients, and control the data clock recovery circuit 100 to enter the normal mode through the mode selection signal MD. Afterwards, a phase tracking loop of the data clock recovery circuit 100 may start to work normally by controlling the sampling clock signal SCK to align the data rate of the analog signal Din and the middle phase of each unit interval.

Incidentally, the controller 190 in the embodiment of the disclosure may be a processor with a computing capability. Alternatively, the controller 190 may be a hardware circuit designed by using a hardware description language (HDL) or any other digital circuit design method known to those skilled in the art, and may be implemented by using a field programmable gate array (FPGA), a complex programmable logic device (CPLD), an application-specific integrated circuit (ASIC), or any form of integrated circuit.

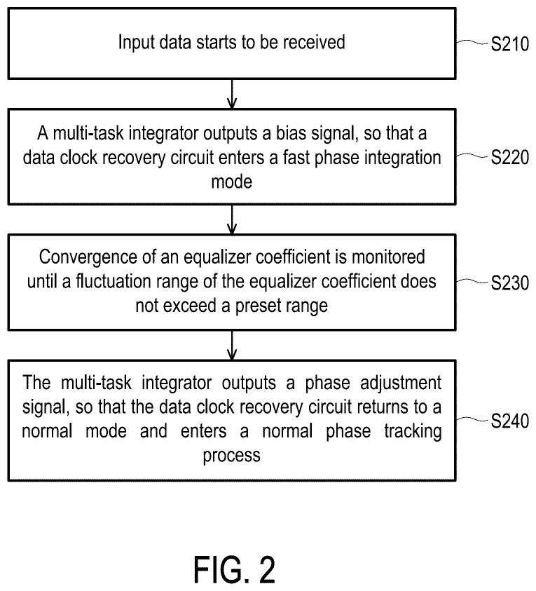

Please refer to FIG. 2 hereinafter. FIG. 2 is a control flow chart of the data clock recovery circuit in FIG. 1 according to an embodiment of the disclosure. In step S210, the data clock recovery circuit 100 starts to receive the analog signal Din. In step S220, the controller 190 controls the multi-task integrator 170 to output the bias signal FPI, so that the data clock recovery circuit 100 enters the fast phase integration mode. In step S230, the convergence of the equalizer coefficient is monitored by the controller 190 until the fluctuation range of the equalizer coefficient does not exceed a preset range. Next, in step S240, in response to the fluctuation range of the equalizer coefficient not exceeding the preset range, the controller 190 controls the multi-task integrator 170 to output the phase adjustment signal Accm, so that the data clock recovery circuit 100 returns to the normal mode and enters the normal phase tracking process.

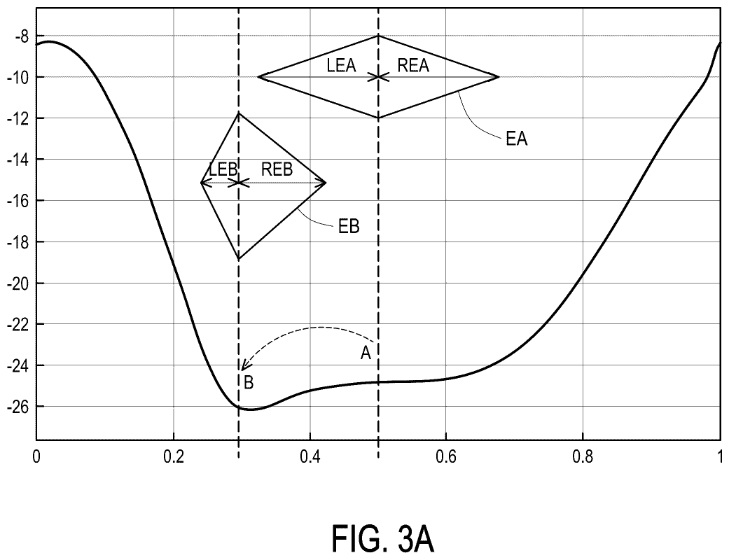

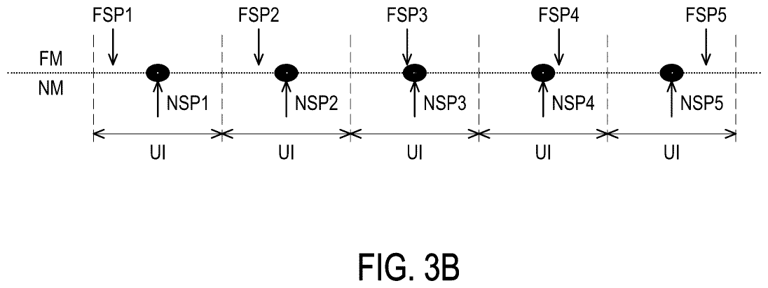

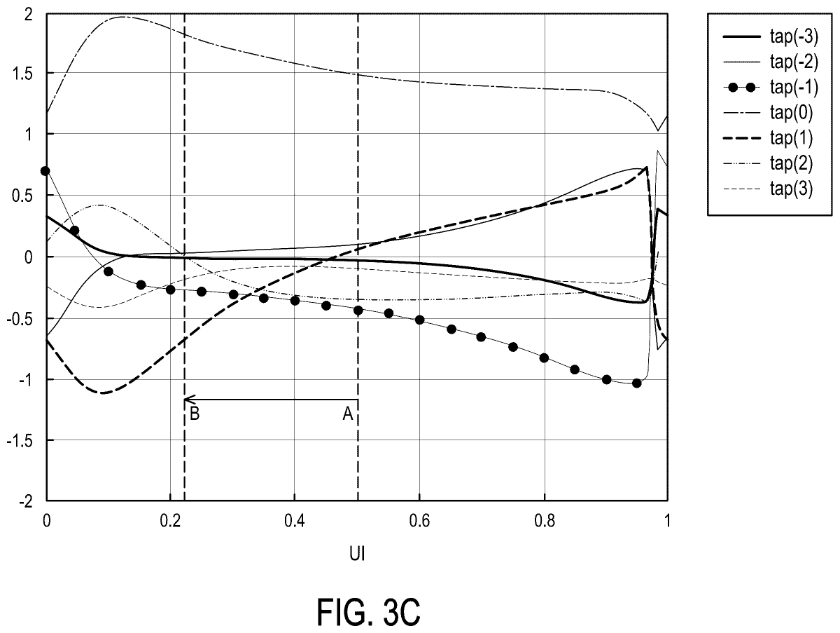

Please refer to FIG. 3A, FIG. 3B, and FIG. 3C hereinafter. FIG. 3A is a diagram of a relationship between an eye width and a magnitude of residual ISI after equalization when a sampling clock is locked at different phases according to an embodiment of the disclosure. FIG. 3B is a schematic diagram of sampling in a fast phase integration mode and a normal mode according to an embodiment of the disclosure. FIG. 3C illustrates convergence targets of equalizer coefficients of an equalizer when a sampling clock is locked to different phases. In FIG. 3A, a horizontal axis represents a unit interval UI, and a vertical axis represents the magnitude of residual ISI. FIG. 3B shows the corresponding relationship between multiple sampling spots in multiple consecutive unit interval UIs in the normal mode NM and the fast integration mode FM.

In the related art, the adaptive equalization loop and the phase tracking loop both rely on the error signal e(k) sequence output by the error calculator for adjustment. The design principle is to find the equalizer coefficient and sampling phase that minimize the square value of the error signal e(k). However, FIG. 3A shows that when the square value of the error signal e(k) is set at a smallest value (B), an eye height of the eye diagram EB is higher, but an eye width is insufficient. Further, a first eye width LEB and a second eye width REB are unbalanced. The first eye width LEB is smaller than the second eye width REB. As a result, the clock jitter tolerance of the circuit is greatly reduced. In actual applications, a difference in the eye height between B and A is small, which has little impact on the bit error rate, but the reduction in clock jitter tolerance has a significant impact on the bit error rate. Therefore, if the equalizer coefficient may be fixed near A, an eye diagram EA may be obtained. A first eye width LEA and a second eye width REA of the eye diagram EA are balanced, which is beneficial to improving the overall performance. The data clock recovery circuit in the embodiment of the disclosure may help the adaptive equalization loop find the equalizer coefficient corresponding to the intermediate phase sampling, thereby obtaining an eye diagram with a large eye width and bilateral symmetry, and maximizing the clock jitter tolerance.

In FIG. 3B, when the fast phase integration mode FM is enabled, the data clock recovery circuit no longer tracks the data frequency and phase. At this time, the sampling clock frequency is 3000 ppm to 5000 ppm, which is higher than the data frequency of the analog signal Din. In other words, after each sampling, the next sampling spot may slide to the right by about 0.4% within the corresponding unit interval UI, so that the sampling phase may traverse each phase. In the normal mode NM, sampling spots NSP1 to NSP5 are fixed at a center point of each unit interval UI. In the fast phase integration mode FM, sampling spots FSP1 to FSP5 slide sequentially in the respective unit interval UI. In this way, the phase of the sampling clock signal may slide point by point within the range from the middle phase −0.5 unit interval to the middle phase 0.5 unit interval.

As shown in FIG. 3C, taking taps tap(−3) to tap(3) as an example, it may be seen that the convergence target values of the equalizer coefficients corresponding to different sampling phases are different. In the fast phase integration mode, the convergence target value of the equalizer coefficient also slides in the phases. The data clock recovery circuit in the embodiment of the disclosure may promote the equalizer coefficient to converge to the average value of each phase convergence target by integrating the bias signal in the fast phase integration mode and the function of the sign-sign least mean square calculator to adaptively adjust the equalizer coefficient. This average value is just near the equalizer coefficient corresponding to the intermediate phase sampling. Therefore, after the fast phase integration mode is enabled, the equalizer coefficients corresponding to each tap may automatically converge to the vicinity of the equalizer coefficients corresponding to the intermediate sampling phase. Therefore, after the equalizer coefficient is stabilized, the normal mode is restored and the eye diagram EA at A in FIG. 3A may be obtained. The sampling position is in the middle of the eye diagram EA, which has the largest clock jitter tolerance.

Finally, it should be noted that the aforementioned embodiments are only used to illustrate the technical solutions of the disclosure, rather than to be limited. Although the disclosure has been described in detail with reference to the foregoing embodiments, a person skilled in the art should understand that the technical solutions described in the foregoing embodiments may still be modified, or some or all of the technical features thereof may be replaced by equivalents. However, these modifications or substitutions do not make the essence of the corresponding technical solutions deviate from the scope of the technical solutions of the embodiments of the disclosure.

What is claimed is:

1. A data clock recovery circuit, comprising:
an analog-to-digital converter, an equalizer, a decider, an error calculator, a phase detection estimator, a loop filter, and a phase interpolator sequentially coupled in series;
a multi-task integrator, coupled between a coupling path of the phase interpolator and the loop filter, and selecting one of a phase adjustment signal and a bias signal according to a mode selection signal to output to the phase interpolator; and
a controller, coupled to the multi-task integrator and generating the mode selection signal by monitoring convergence of an equalizer coefficient.

2. The data clock recovery circuit according to claim 1, wherein the bias signal is a constant value.

3. The data clock recovery circuit according to claim 1, wherein the multi-task integrator generates the phase adjustment signal by integrating a filtered output signal of the loop filter.

4. The data clock recovery circuit according to claim 1, wherein a difference between the bias signal and the phase adjustment signal is greater than a first preset threshold.

5. The data clock recovery circuit according to claim 1, further comprising:
a sign-sign least mean square calculator, coupled to the equalizer, the error calculator, and the controller, and configured to continuously calculate and update the equalizer coefficient according to an error signal output by the error calculator, and output the updated equalizer coefficient to the equalizer and the controller.

6. The data clock recovery circuit according to claim 5, wherein the controller monitors the convergence of the equalizer coefficient according to the received equalizer coefficient, and notifies the sign-sign least mean square calculator to stop calculating the equalizer coefficient when a fluctuation range of the equalizer coefficient is within a preset range.

7. The data clock recovery circuit according to claim 6, wherein the controller controls the multi-task integrator to output the bias signal when the circuit is initialized, so that the circuit enters a fast phase integration mode, and controls the multi-task integrator to output the phase adjustment signal when the fluctuation range of the equalizer coefficient is within the preset range, so that the circuit enters a normal mode.

8. The data clock recovery circuit according to claim 1, wherein the equalizer is a forward feedback equalizer, a decision feedback equalizer, or a combination of the forward feedback equalizer and the decision feedback equalizer.

9. The data clock recovery circuit according to claim 1, wherein the loop filter is a phase integration filter.

10. The data clock recovery circuit according to claim 7, wherein the phase interpolator adjusts a local clock signal according to an output signal of the multi-task integrator to generate a sampling clock signal.

11. The data clock recovery circuit according to claim 10, wherein in the fast phase integration mode, a difference between a frequency of the sampling clock signal and a frequency of an analog signal sampled by the analog-to-digital converter is 3000 ppm to 5000 ppm.

12. The data clock recovery circuit according to claim 11, wherein in the fast phase integration mode, a phase of the sampling clock signal slides point by point within a range from an intermediate phase of −0.5 unit interval to an intermediate phase of 0.5 unit interval.
